(19) United States
(12) Patent Application Publication
(10) Pub. No.: US 2023/0373806 A1
(43) Pub. Date: Nov. 23, 2023

(54) Nanoporous Cerium Oxide Nanoparticle Macro-Structures In Polymeric Elastomers

(71) Applicant: Xheme Inc., Newton, MA (US)

(72) Inventor: Siva Sai Ramana Kumar Challa, Newton, MA (US)

(21) Appl. No.: 17/664,253

(22) Filed: May 20, 2022

(51) Int. Cl. C01F 17/235; C08K 3/22

(52) U.S. Cl. CPC C01F 17/235; C08K 3/22; B82Y 30/00

(57) ABSTRACT

The present invention is directed to nanoporous cerium oxide nanoparticle (NCeONP) macro-structures in polymeric elastomers. Such macrostructures can be used to modify the mechanical properties of the polymeric elastomer and influence the response to UV exposure.

The present invention is directed to nanoporous cerium oxide nanoparticle (NCeONP) macro-structures as additives to polymeric elastomers.

### BACKGROUND

Cerium based oxide compounds have been reported. For example, cerium oxide is an oxide of the rare-earth metal cerium. Cerium oxide nanoparticles have received attention in the scientific literature due to, e.g., their catalytic activity and antioxidant properties. Research to identify and improve upon the performance of cerium oxide nanoparticles therefore remains an on-going research and development focus, to identify additional enhancements to their structure, properties and applications.

In U.S. application Ser. No. 17/390,199, entitled Nanoporous Cerium Oxide Nanoparticle Macro-Structure, there is disclosure of nanoporous cerium oxide nanoparticle macro-structures comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm. There is also disclosure of the use of such macro-structures in formulations with a pigment or dye to augment the performance of the pigment and/or dye with regards to, among other things, ability to retain color intensity and resistance to fading on exposure to ultraviolet (UV) radiation.

### SUMMARY

A composition comprising nanoporous cerium oxide nanoparticle macro-structures, in a polymeric elastomer, comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm.

A method of forming a composition comprising: supplying nanoporous cerium oxide nanoparticle macro-structures comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; supplying a polymeric elastomer; and mixing said nanoporous cerium oxide nanoparticle macro-structure with said polymeric elastomer.

A method of modifying one or more mechanical property characteristics of a polymeric elastomer comprising supplying a polymeric elastomer having an initial value for ultimate tensile strength, elongation and modulus at 100% strain and adding to said polymeric elastomer nanoporous cerium oxide nanoparticle macro-structures at a level of 0.1% (wt.) to 5.0% (wt.); wherein one or more of the following is observed: an increase in the initial value of ultimate tensile strength by at least 5.0%; an increase in the initial value of elongation by at least 10.0%; and/or a reduction in the initial value of the modulus at 100% strain by at least 50.0%.

A method of modifying the response of a polymeric elastomer' s mechanical properties to UV exposure comprising supplying a polymeric elastomer and adding to said polymeric elastomer nanoporous cerium oxide nanoparticle macro-structures at a level of 0.1% (wt.) to 5.0% (wt.) and exposing the polymeric elastomer to 200 hours of UV light wherein the polymer elastomer indicates: (1) an ultimate tensile strength that at least 10.0% higher than the ultimate tensile strength of the polymeric elastomer, after 200 hours of UV exposure, without the NCeONP macrostructures; (2) an elongation that is at least 30.0% higher than the than the elongation of the polymeric elastomer, after 200 hours of UV exposure, without the NCeONP macrostructures; and/or (3) a modulus at 100% strain that is at least 50% lower than the modulus at 100% strain of the polymeric elastomer, after 200 hours of UV exposure, without the NCeONP macrostructures.

### BRIEF DESCRIPTION OF THE DRAWINGS

Aspects of the present disclosure may be appreciated upon review of the description herein and the accompanying drawings which identify as follows:

FIG. 1 illustrates cerium oxide nanoparticles.

FIG. 2 illustrates the nanoporous cerium oxide nanoparticle (NCeONP) macro-structure formed from the cerium oxide nanoparticles illustrated in FIG. 1.

FIG. 3 is a scanning electron micrograph of the cerium oxide nanoparticles employed herein to form the nanoporous cerium oxide nanoparticle macro-structure.

FIGS. 4A, 4B and 4C, respectively, provide scanning electron micrographs at increasing magnification showing the nanoporous cerium oxide nanoparticle macro-structure herein formed from the cerium oxide nanoparticles of FIG. 3.

FIG. 5A shows SBR compounded without any nanoporous cerium oxide nanoparticle (control).

FIG. 5B shows SBR compounded with 3.0 wt. % of the nanoporous cerium oxide nanoparticle (NCeONP) macrostructures herein.

### DETAILED DESCRIPTION OF PREFERRED EMBODIMENTS

The present disclosure is directed at preparation procedures and resulting compositions related to the combination of nanoporous cerium oxide nanoparticle macro-structures in polymeric elastomers.

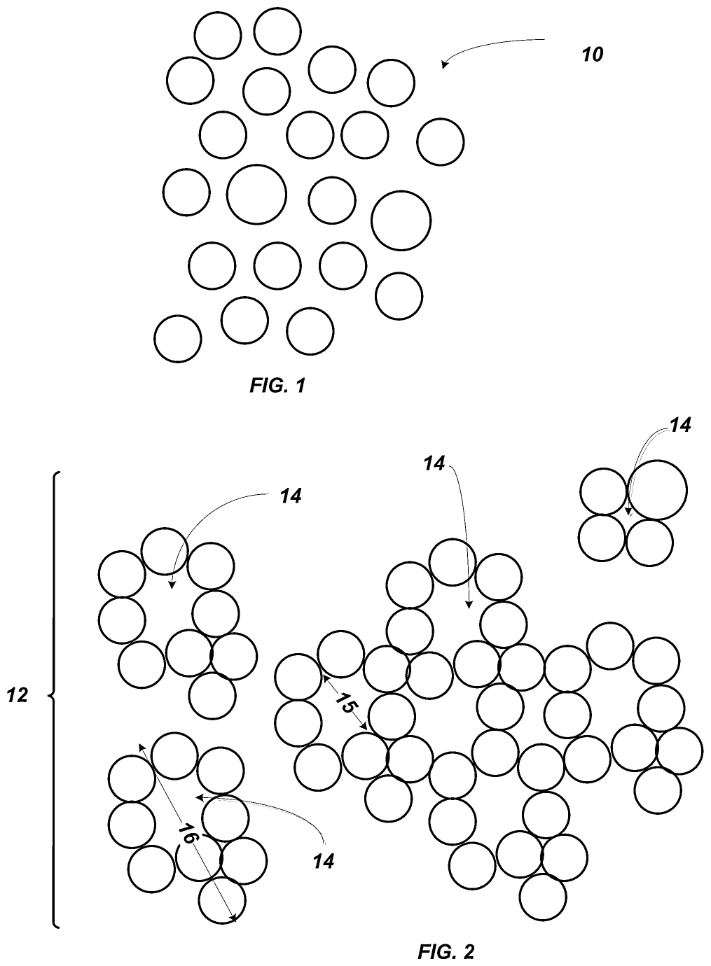

Reference to a macro-structure is reference to the feature that a plurality of the particles associate or adhere to one another where the macro-structure has its own pore size diameter. With attention to FIG. 1, preferably, the starting cerium oxide nanoparticles 10 have a diameter (largest linear dimension) in the range of 10 nm to 100 nm. More preferably, the cerium oxide nanoparticles employed herein have a diameter in the range of 10 nm to 50 nm or 10 nm to 30 nm or 20 nm to 30 nm.

The above referenced cerium oxide nanoparticles are then preferably degassed with nitrogen for a preferred period of 30 minutes to 60 minutes. This is then preferably followed by heating at elevated temperature, and preferably at the temperature range of 50° C. to 900° C. for a preferred period of 1.0 hour to 3.0 hours, more preferably 1.0 hour to 2.0 hours. Accordingly, such heating of the cerium oxide nanoparticles was observed to form a plurality of nanoporous cerium oxide nanoparticle macro-structures 12 illustrated in FIG. 2 having macro-structure pores 14.

The macro-structure pores 14 that are formed by the cerium oxide nanoparticle macrostructure 12 preferably have a diameter (largest linear dimension) as indicated by arrow 15 in the range of 10 nm to 1100 nm, more preferably, 10 nm to 750 nm or 10 nm to 500 nm or 10 nm to 250 nm or 10 nm to 100 nm or 10 nm to 50 nm or 10 nm to 25 nm. In addition, the nanoporous cerium oxide nanoparticle macro-structures 12 themselves are contemplated to have a preferred diameter (largest linear dimension) as indicated by arrow 16 in the range of 50 nm to 30,000 nm.

In one particularly preferred embodiment, the nanoporous cerium oxide nanoparticle (NCeONP) macro-structures that are formed herein have a binary size distribution with respect to both their macro-structure diameter 16 and macro-structure pore diameter 15. A binary size distribution is reference to two distributions of size ranges for both the macro-structure diameter and macro-structure pore diameter. That is, the preparation methods herein preferably provide a nanoporous cerium oxide nanoparticle macro-structure that has the following binary size distribution: (1) macro-structure diameter in the range of 10 nm to 300 nm with a macro-structure pore diameter in the range of 5 nm to 30 nm, more preferably 10 nm to 20 nm; and (2) macro-structure diameter in the range of 5,000 nm to 30,000 nm with a macro-structure pore diameter in the range of 900 nm to 1100 nm.

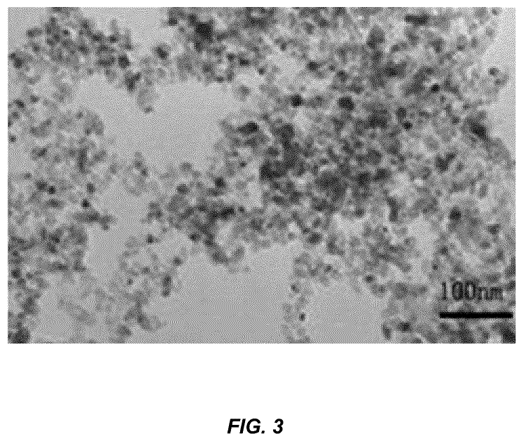

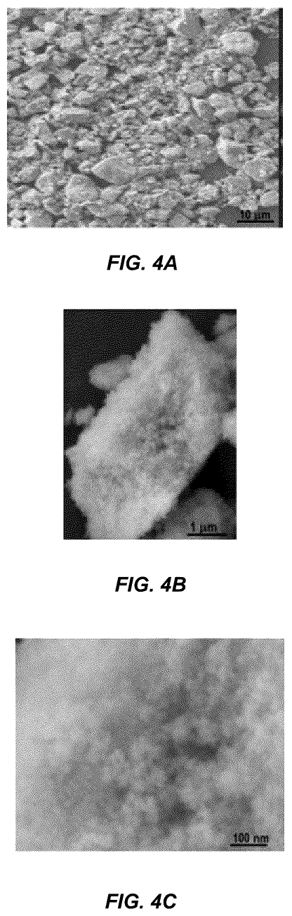

FIG. 3 is a scanning electron micrograph of the cerium oxide nanoparticles employed herein to form the nanoporous cerium oxide nanoparticle macro-structure. As noted above, such starting cerium oxide nanoparticles preferably had a diameter of 20 nm to 30 nm. FIGS. 4A, 4B and 4C, respectively, provide scanning electron micrographs at increasing magnification showing the nanoporous cerium oxide nanoparticle macro-structure herein formed from the cerium oxide nanoparticles of FIG. 3, wherein the macro-structure itself forms macro-structure pores 14 (see again FIG. 1).

The above referenced NCeONP macro-structures can now be incorporated into polymeric elastomer. Reference to a polymeric elastomer herein includes reference to a polymeric material, that retracts within one minute to less than 1.5 times its original length after being stretch at room temperature (18° C. to 29° C.) to twice its length and held for one minute before release. Further examples of polymeric elastomers herein, based upon individual polymeric structure, include polyisoprene, polybutadiene, chloroprene rubber, butyl rubber, styrene-butadiene rubber, nitrile rubber. Other polymeric elastomers further include polysiloxane elastomers, and thermoplastic elastomers, such as polyurethane thermoplastic elastomers, polyester thermoplastic elastomers, and polyamide thermoplastic elastomers.

Preferably, the nanoporous cerium oxide nanoparticle (NCeONP) macro-structures are compounded into the polymeric elastomer herein utilizing heat and some amount of shear mixing. More specifically, the polymeric elastomer and the nanoporous cerium oxide nanoparticle (NCeONP) macro-structures may be loaded into a mixer (e.g. a Banbury mixer). The polymeric elastomer and nanoporous cerium oxide nanoparticle (NCeONP) macro-structures, optionally with additional ingredients, may then be kneaded until the torque output is stabilized. Typically this can be achieved over a 5-10 minute period. The temperature of the mixing chamber may preferably be set in the range of 50° C. to 75° C., which can vary depending upon the particular polymeric elastomer being utilized. The compounded mixture of the nanoporous cerium oxide nanoparticle (NCeONP) macro-structures and polymeric elastomer may then be shaped into strips via the use of a two-roll mill with a roller temperature in the range of 50° C. to 75° C., which again can vary depending upon the polymeric elastomer at issue. Elastomeric polymeric material, for control purposes, was similarly processed.

By way of a representative example, the nanoporous cerium oxide nanoparticle (NCeONP) macro-structures was compounded a polymeric elastomer, namely styrene-butadiene rubber (SBR), according to the above referenced protocol. In addition, the compounded rubber strips so produced were also heated and pressed at 2400 N at a temperature of 145° C., for a period of 30 to 40 minutes. The SBR was also subjected to crosslinking due to the presence of sulfur.

The level of loading of nanoporous cerium oxide nanoparticle (NCeONP) macro-structures into the polymeric elastomer preferably falls in the range of 0.1% to 5.0% by weight, including all individual values and increments therein. Accordingly, the level of nanoporous cerium oxide nanoparticle (NCeONP) macro-structures in the polymeric elastomer may be 0.1% (wt.), 0.2% (wt.), 0.3% (wt.), 0.4% (wt.), 0.5% (wt.), 0.6% (wt.), 0.7% (wt.), 0.8% (wt.), 0.9% (wt.), 1.0% (wt.), 1.1% (wt.). 1.2% (wt.). 1.3% (wt.), 1.4% (wt.). 1.5% (wt.), 1.6% (wt.), 1.7% (wt.), 1.8% (wt.), 1.9% (wt.), 2.0% (wt.), 2.1% (wt.), 2.2% (wt.), 2.3% (wt.), 2.4% (wt.), 2.5% (wt.), 2.6% (wt.), 2.7% (wt.), 2.8% (wt.), 2.9% (wt.), 3.0% (wt.), 3.1% (wt.), 3.2% (wt.), 3.3% (wt.), 3.4% (wt.), 3.5% (wt.), 3.6% (wt.), 3.7% (wt.), 3.8% (wt.), 3.9% (wt.), 4.0% (wt.), 4.1% (wt.), 4.2% (wt.), 4.3% (wt.), 4.4% (wt.), 4.5% (wt.), 4.6% (wt.), 4.7% (wt.), 4.8% (wt.), 4.9% (wt.) and 5.0% (wt.). For example, the level of loading of the nanoporous cerium oxide nanoparticle (NCeONP) macro-structures into the polymeric elastomer may fall in the range of 1.0% (wt.) to 4.0% (wt.), or 2.0% (wt.) to 4.0% (wt.), or 3.0% (wt.) to 4.0% (wt.).

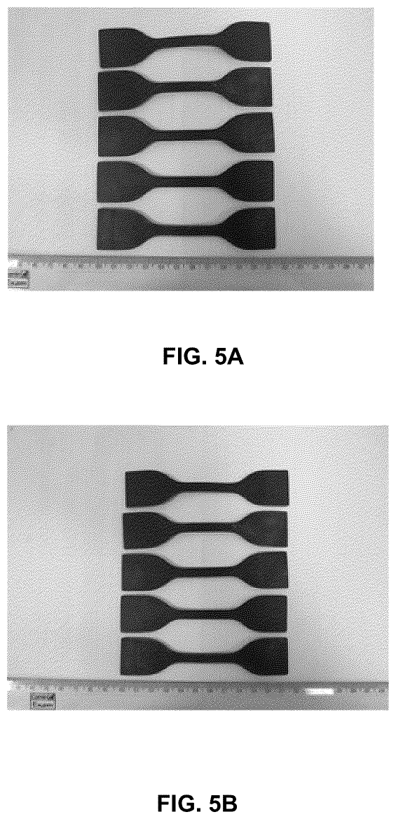

By way of a more specific representative example, nanoporous cerium oxide nanoparticle (NCeONP) macro-structure was incorporated into styrene-butadiene rubber (SBR) at a level of 3.0% (wt.). FIG. 5A shows SBR compounded without any nanoporous cerium oxide nanoparticle (control) and FIG. 5B shows SBR compounded with 3.0 wt. % of the nanoporous cerium oxide nanoparticle (NCeONP) macrostructures herein. As noted above, the SBR that was utilized was also crosslinked due to the presence of sulfur.

The above referenced compounded SBR, containing 3.0% (wt.) of nanoporous cerium oxide nanoparticle (NCeONP) macro-structures, was evaluated for mechanical property performance, before and after UV exposure, versus a control SBR. The results are provided in Table 1 below. It is worth noting that in Table 1 below, two sets of 5 samples each were tested for the selected mechanical property criteria. An average value was then reported.

TABLE 1
Mechanical Properties of SBR Loaded With Nanoporous
Cerium Oxide Nanoparticle Macrostructures

| | Ultimate | | | |
|---|---|---|---|---|
| | Tensile | | Modulus at | |
| | Strength | Elongation | 100% | Maximum |
| Specimen | (MPa) | % | Strain (Pa) | Force (N) |
| SBR without NCeONP | 16.0 | 495.8 | 3.20 | 188.4 |
| Macrostructures | | | | |
| (Before UV exposure) | | | | |
| SBR without NCeONP | 15.6 | 426.3 | 3.71 | 182.0 |
| Macrostructures | | | | |
| (After 200 Hours UV | | | | |
| exposure) | | | | |
| SBR with NCeONP | 17.2 | 563.8 | 1.82 | 226.9 |
| Macrostructures | | | | |
| (Before UV exposure) | | | | |
| SBR with NCeONP | 17.3 | 550.0 | 1.90 | 226.0 |
| Macrostructures | | | | |
| (After 200 Hours UV | | | | |
| exposure) | | | | |

As can be seen from the above, SBR without any NCeONP macrostructures, indicated an ultimate tensile strength of 16.0 MPa, an elongation of 495.8%, a modulus at 100% strain of 3.20 Pa and a maximum force of 188.4 N. The addition of 3.5% (wt.) NCeONP macrostructures increased the ultimate tensile strength to a value of 17.2 MPa, increased the elongation to 563.8%, lowered the modulus at 100% strain to 1.82 Pa, and increased the maximum force to 226.9 N. From this data it is clear that the addition of NCeONP macrostructures herein to polymeric elastomers will increase both ultimate tensile strength and elongation and reduce the value of the modulus at 100% strain. The reduction in modulus at 100% strain reflects the feature that relatively less force will be necessary to elongation to 100%.

Accordingly, it can be appreciated herein that one can now supply a polymeric elastomer that has an initial value for ultimate tensile strength (UTS₁), an initial value of elongation (E₁) and an initial value of modulus at 100% strain (M₁₀₀), and upon addition of the NCeONP macrostructures, at a loading level of 0.1% (wt.) to 5.0% (wt.), one can provide a polymeric elastomer with one or more of the following: (1) an ultimate tensile strength that at least 5.0% higher, or more preferably in the range of 5% to 10% higher than the initial value for ultimate tensile strength; (2) an elongation that is at least 10.0% higher, or more preferably 10.0% to 20.0% higher, than the initial value of elongation; and/or (3) a modulus at 100% strain that is at least 50.0% lower, or more preferably in the range of 50.0% to 60.0% lower, than the initial value of modulus at 100% strain.

SBR, without any NCeONP macrostructures, after 200 hours of UV exposure, indicated an ultimate tensile strength of 15.6 MPa, an elongation of 426.3%, a modulus at 100% strain of 3.71 Pa and a maximum force of 182 N. SBR, with NCeONP macrostructures, after 200 hours of UV exposure, indicated a higher ultimate tensile strength of 17.3 MPa, a higher elongation of 550.0%, a lower modulus at 100% strain of 1.90 Pa and a higher maximum force of 226 N.

Accordingly, it can be appreciated herein that one can now supply a polymeric elastomer that has an initial value, after UV exposure of 200 hours, for ultimate tensile strength (UTS₁), elongation (E₁) and modulus at 100% strain (M₁₀₀), wherein the addition of the NCeONP macrostructures, at a loading level of 0.1% (wt.) to 5.0% (wt.), and after UV exposure, one can provide a polymeric elastomer with: (1) an ultimate tensile strength that at least 10.0% higher, or more preferably in the range of 5.0% to 15.0% higher, than the ultimate tensile strength of the polymeric elastomer, after 200 hours of UV exposure, without the NCeONP macrostructures; (2) an elongation that is at least 30.0% higher, or more preferably in the range of 25.0% to 35.0% higher, than the than the elongation of the polymeric elastomer, after 200 hours of UV exposure, without the NCeONP macrostructures ; and/or (3) a modulus at 100% strain that is at least 50% lower, or more preferably in the range of 50% to 60% lower, than the modulus at 100% straing of the polymeric elastomer, after 200 hours of UV exposure, without the NCeONP macrostructures.

It can therefore be seen that the addition of the NCeONP in polymeric elastomers, can serve to improve the mechanical properties (increasing the values of ultimate tensile strength, elongation, and reducing the value of the modulus at 100% strain). In addition, the addition of the NCeONP is polymeric elastomers, improves mechanical property performance, after UV weathering. Again, one observes an increase in ultimate tensile strength, elongation, and a reduction in the modulus at 100% strain.

It is worth noting that the polymeric elastomers herein may contain a number of other additives, in combination with the NCeONP macrostructures. Such additives can include sulfur, accelerators, metal oxide (e.g. zinc oxide) and stearic acid. Fillers can include carbon black and/or silicon dioxide. Protective chemicals can include those additives that confer resistance to heat, sunlight, oxygen and/or ozone. For example, hindered amines, hindered phenols. Other additives can include plasticizers, such as aliphatic esters and phthalates and/or processing aids, such as liquid lubricants.

From the above, the cerium oxide nanoparticle macro-structures herein, comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm, have been demonstrated to improve the mechanical properties of polymeric elastomers.

1. A composition comprising:
nanoporous cerium oxide nanoparticle macro-structures, in a polymeric elastomer, comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm.

2. The composition of claim 1 wherein said nanoporous cerium oxide nanoparticle macro-structure is present in said polymeric elastomer at a level of 0.1% (wt.) to 5.0% (wt.).00

3. The composition of claim 1 wherein said plurality of cerium oxide nanoparticles have a diameter in the range of 10 nm to 50 nm.

4. The composition of claim 1 wherein said plurality of cerium oxide nanoparticles have a diameter in the range of 10 nm to 30 nm.

5. The composition of claim 1 wherein said plurality of cerium oxide nanoparticles have a diameter in the range of 20 nm to 30 nm.

6. The composition of claim 1 wherein said macro-structure pore diameter is in the range of 10 nm to 750 nm.

7. The composition of claim 1 claim 1 wherein said macro-structure pore diameter is in the range of 10 nm to 500 nm.

8. The composition of claim 1 wherein said macro-structure pore diameter is in the range of 10 nm to 250 nm.

9. The composition of claim 1 wherein said macro-structure pore diameter is in the range of 10 nm to 100 nm.

10. The composition of claim 1 wherein said macro-structure pore diameter is in the range of 10 nm to 50 nm.

14. The composition of claim 1 wherein said macro-structure pore diameter is in the range of 10 nm to 25 nm.

15. The composition of claim 1 wherein said polymeric elastomer is selected from the group consisting of polyisoprene, polybutadiene, chloroprene rubber, butyl rubber, styrene-butadiene rubber, nitrile rubber, polysiloxane elastomers, polyurethane thermoplastic elastomers, polyester thermoplastic elastomers, or polyamide thermoplastic elastomers.

16. A method of forming a composition comprising:
(a) supplying nanoporous cerium oxide nanoparticle macro-structures comprising a plurality of cerium oxide nanoparticles having a diameter in the range of 10 nm to 100 nm present as a macro-structure having macro-structure diameter in the range of 50 nm to 30,000 nm and macro-structure pore diameter in the range of 10 nm to 1100 nm; and
(b) supplying a polymeric elastomer; and
(c) mixing said nanoporous cerium oxide nanoparticle macro-structure with said polymeric elastomer.

17. The method of claim 15 wherein said nanoporous cerium oxide nanoparticle macro-structure are mixed with said polymeric elastomer at a level of 0.1% (wt.) to 5.0% (wt.).

18. The method of claim 15 wherein said polymeric elastomer is selected from the group consisting of polyisoprene, polybutadiene, chloroprene rubber, butyl rubber, styrene-butadiene rubber, nitrile rubber, polysiloxane elastomers, polyurethane thermoplastic elastomers, polyester thermoplastic elastomers, or polyamide thermoplastic elastomers.

19. A method of modifying one or more mechanical property characteristics of a polymeric elastomer comprising:
supplying a polymeric elastomer having an initial value for ultimate tensile strength, elongation and modulus at 100% strain;
adding to said polymeric elastomer nanoporous cerium oxide nanoparticle macro-structures at a level of 0.1% (wt.) to 5.0% (wt.), wherein one or more of the following is observed:
an increase in the initial value of ultimate tensile strength by at least 5.0%;
an increase in the initial value of elongation by at least 10.0%; and/or
a reduction in the the initial value of the modulus at 100% strain by at least 50.0%.

20. A method of modifying the response of a polymeric elastomer's mechanical properties to UV exposure comprising:
supplying a polymeric elastomer and adding to said polymeric elastomer nanoporous cerium oxide nanoparticle macro-structures at a level of 0.1% (wt.) to 5.0% (wt.);
exposing the polymeric elastomer to 200 hours of UV light wherein the polymeric elastomer indicates:
(1) an ultimate tensile strength that at least 10.0% higher than the ultimate tensile strength of the polymeric elastomer, after 200 hours of UV exposure, without the NCeONP macrostructures; (2) an elongation that is at least 30.0% higher than the than the elongation of the polymeric elastomer, after 200 hours of UV exposure, without the NCeONP macrostructures; and/or (3) a modulus at 100% strain that is at least 50% lower than the modulus at 100% strain of the polymeric elastomer, after 200 hours of UV exposure, without the NCeONP macrostructures.
